(19) United States
(12) Patent Application Publication
(10) Pub. No.: US 2020/0342294 A1
(43) Pub. Date: Oct. 29, 2020

(54) NEURAL NETWORK ACCELERATING APPARATUS AND OPERATING METHOD THEREOF

(71) Applicant: SK hynix Inc., Icheon (KR)

(72) Inventor: Jae Hyeok JANG, Icheon (KR)

(21) Appl. No.: 16/696,717

(22) Filed: Nov. 26, 2019

(30) Foreign Application Priority Data
Apr. 26, 2019 (KR) 10-2019-0049176

(51) Int. Cl. G06N 3/063; G06N 3/04

(52) U.S. Cl. CPC G06N 3/063; G06N 3/04

(57) ABSTRACT

A neural network accelerating apparatus includes a zero-value filter configured to filter a zero (0) value by applying a weight to an input feature and generate compressed packet data by matching index information including relative coordinates and group boundary information for data elements of the input feature, a multiplier configured to produce result data by performing a multiplication operation on the input feature and the weight of the compressed packet data, and a feature map extractor configured to perform an addition operation between multiplied result data based on the relative coordinates and the group boundary information of the result data transferred from the multiplier and generate an output feature map by rearranging result values of the addition operation.

### CROSS-REFERENCES TO RELATED APPLICATION

The present application claims priority under 35 U.S.C. § 119(a) to Korean application number 10-2019-0049176, filed on Apr. 26, 2019, in the Korean Intellectual Property Office, which is incorporated herein by reference in its entirety.

### BACKGROUND

### 1. Technical Field

Various embodiments may generally relate to a semiconductor device, and more particularly, to a neural network accelerating apparatus and an operating method thereof.

### 2. Related Art

Convolutional neural network (CNN) applications may be neural network applications mainly used for image recognition and analysis. The applications may require a convolution operation which extracts features from an image using a specific filter. A matrix multiplication unit which performs a multiplication operation and an addition operation may be used for the convolution operation. When a distribution of 0 (zero) in the coefficients of the convolution is small, for example, when sparsity (the fraction that are equal to zero) of the coefficients is small, the matrix multiplication unit may be efficiently used to process the dense (i.e., low sparsity) image and filter. However, since most of the images and filters used in CNN applications may have sparsity of about 30 to 70%, a large number of zero (0) values may be included. The zero values may cause unnecessary latency and power consumption in performing of the convolution operations.

Accordingly, methods for efficiently performing convolution operations in CNN applications are desired.

### SUMMARY

Embodiments are provided to a neural network accelerating apparatus with improved operation performance and an operating method thereof.

In an embodiment of the present disclosure, a neural network accelerating apparatus may include: a zero-value filter configured to filter a zero (0) value by applying a weight to an input feature, the input feature including a plurality of data elements, and generate compressed packet data by matching index information including relative coordinates and group boundary information with the data elements of the input feature; a multiplier configured to produce result data by performing a multiplication operation on the input feature and the weight of the compressed packet data; and a feature map extractor configured to perform an addition operation between the result data based on the relative coordinates and the group boundary information and generate an output feature map by rearranging result values of the addition operation in an original input feature form.

In an embodiment of the present disclosure, an operating method of a neural network accelerating apparatus may include: receiving an input feature and a weight, the input feature including a plurality of data elements; filtering a zero (0) value by applying the weight to the input feature and generating compressed packet data by matching index information including relative coordinates and group boundary information for the data elements of the input feature; producing result data by performing a multiplication operation on the input feature and the weight of the compressed packet data; performing an addition operation between multiplied result data based on the relative coordinates and the group boundary information of the result data and generating an output feature map by rearranging result values of the addition operation in an original input feature form; and changing the output feature map to nonlinear values by applying an activation function to the output feature map and generating a final output feature map by performing a pooling process.

According to an embodiment of the present disclosure, the effect of the improvement in operation performance of the neural network accelerating apparatus may be expected since skip of zero values of an input feature and a weight is supported according to a stride value.

According to an embodiment of the present disclosure, the unnecessary latency and power consumption may be reduced.

These and other features, aspects, and embodiments are described below in the section entitled “DETAILED DESCRIPTION”.

### BRIEF DESCRIPTION OF THE DRAWINGS

The above and other aspects, features and advantages of the subject matter of the present disclosure will be more clearly understood from the following detailed description taken in conjunction with the accompanying drawings, in which:

FIG. 1 illustrates a configuration of a neural network accelerating apparatus according to an embodiment of the present disclosure.

FIG. 2 illustrates a method of grouping data elements (e.g., pixels) of an input feature according to an embodiment of the present disclosure.

FIGS. 3 and 4 illustrate an example of packet data according to an embodiment of the present disclosure.

FIG. 5 illustrates a method of detecting a zero value of an input feature according to an embodiment of the present disclosure.

FIG. 6 illustrates a method of detecting a zero value of a weight according to an embodiment of the present disclosure.

FIGS. 7, 8, 9, and 10 illustrate methods of detecting a non-zero value by applying a weight to an input feature according to an embodiment of the present disclosure.

FIG. 11 is a flowchart of an operating method of a neural network accelerating apparatus according to an embodiment of the present disclosure.

FIG. 12 is a flowchart of a method of generating compressed packet data in FIG. 11 in more detail.

### DETAILED DESCRIPTION

Various embodiments of the present invention will be described in greater detail with reference to the accompanying drawings. The drawings are schematic illustrations of various embodiments (and intermediate structures). As such, variations from the configurations and shapes of the illustrations as a result, for example, of manufacturing techniques and/or tolerances, are to be expected. Thus, the described embodiments should not be construed as being limited to the particular configurations and shapes illustrated herein but may include deviations in configurations and shapes which do not depart from the scope of the present invention as defined in the appended claims.

The present invention is described herein with reference to illustrations of embodiments of the present invention. However, embodiments of the present invention should not be construed as limiting the inventive concept. Although a few embodiments of the present invention will be shown and described, it will be appreciated by those of ordinary skill in the art that changes may be made in these embodiments without departing from the principles of the present invention.

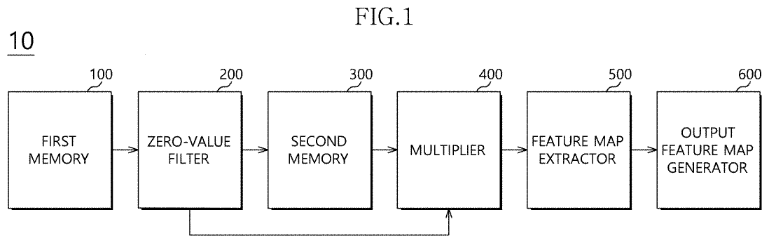

FIG. 1 is a diagram illustrating a configuration of a neural network accelerating apparatus according to an embodiment.

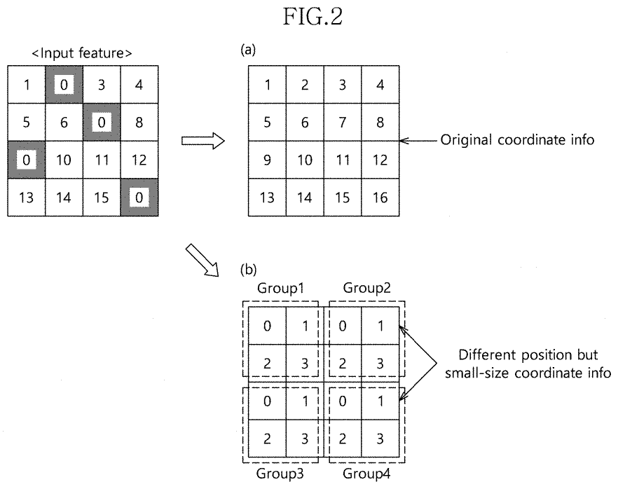

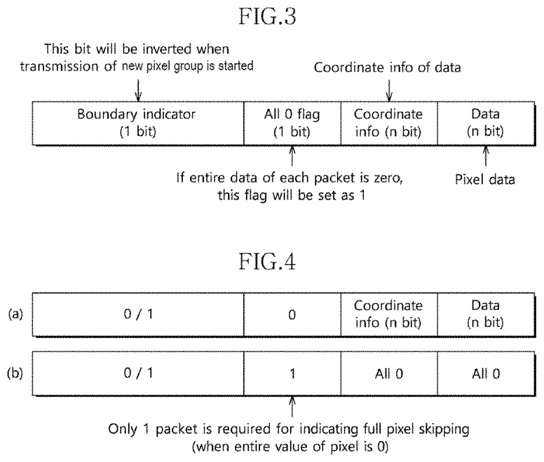

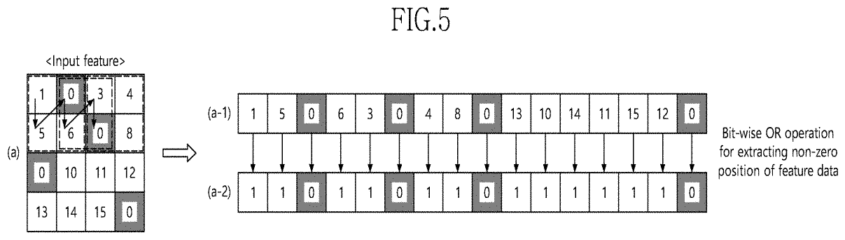

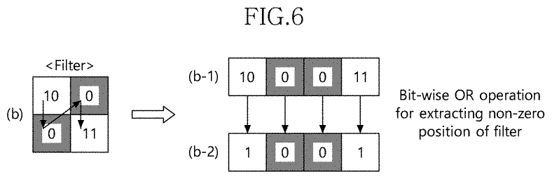

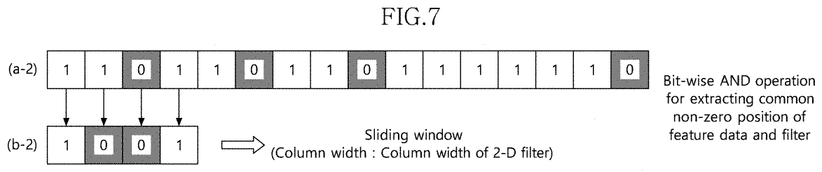

Hereinafter, a neural network accelerating apparatus and an operating method thereof will be described with reference to FIGS. 2 to 10. FIG. 2 illustrates a method of grouping data elements (for example, pixels) of an input feature according to an embodiment, FIGS. 3 and 4 illustrate an example of packet data according to an embodiment, FIG. 5 illustrates a method of detecting a zero value of an input feature according to an embodiment, FIG. 6 illustrates a method of detecting a zero value of a weight according to an embodiment, and FIGS. 7 to 10 illustrate methods of detecting a non-zero value by applying a weight to an input feature according to an embodiment.

Referring to FIG. 1, a neural network accelerating apparatus 10 according to an embodiment may include a first memory 100, a zero-value filter 200, a second memory 300, a multiplier 400, a feature map extractor 500, and an output feature map generator 600.

The first memory 100 may store information related to the neural network accelerating apparatus 10 including a feature and a weight and transmit the stored feature and weight to the zero-value filter 200. The feature may be image data or voice data, but in the illustrative examples provided herein will be assumed to be image data composed of pixels. The weight may be a filter used to filter the zero value from the feature. The first memory 100 may be implemented with a dynamic random access memory (DRAM), but embodiments are not limited thereto.

The zero-value filter 200 may filter out zero (0) values by applying the weight to the input feature and may generate compressed packet data by matching index information including relative coordinates and group boundary information to the pixels of the input feature that are not filtered out. The input feature and the weight may be produced from the first memory 100.

The zero-value filter 200 may perform zero-value filtering using zero-value positions of the input feature and the weight and a stride value. The stride value may refer to an interval value which applies the filter. Referring to FIG. 7, the stride value may be a moving interval in sliding window of a filter (weight) b-2 with respect to an input feature a-2.

The zero-value filter 200 may group pixels of the input feature according to a preset criterion, generate relative coordinates between a plurality of groups, and match the relative coordinates with the pixels of each group.

Referring to FIG. 2, the zero-value filter 200 may group the pixels of the input feature into a group 1, a group 2, a group 3, and a group 4 (see b in FIG. 2), generate the relative coordinates indicating the same coordinates with respect to the same positions of the groups, and match the relative coordinates with the pixels within each group. The original coordinates (see (a) in FIG. 2) for the input feature may be 1, 2, 3, 4, . . . , 15, and 16 and the coordinates (see (b) in FIG. 2) for each of the groups in the input feature may be 0, 1, 2, and 3. For example, the coordinates of the grouped input feature may be 1, 2, and 3 of the group 1; 0, 1, 2, and 3 of the group 2; 0, 1, 2, and 3 of the group 3; and 0, 1, 2, and 3 of the group 4. Through the generation of the relative coordinates between the groups, the size of the index value to be stored may be reduced.

Here, each pixel may have the boundary indication expressing group boundary information and the output feature map generator 600 may determine whether to transmit a new pixel group using the group boundary information. The group boundary information may refer to 1-bit information for dividing the plurality of groups.

FIGS. 3 and 4 illustrate an example of compressed packet data. Referring to FIG. 3, the compressed packet data may include a group boundary information “boundary indicator,” a zero flag “all 0 flag” indicating whether all corresponding pixel data have a zero (0) value, a coordinate “coordinate info” of pixel data, and the pixel data “Data.” The group boundary information and the zero flag may each be represented with 1-bit, for example, the value of 1 or 0. The value 1 or 0 of the boundary information may be inverted to the value 0 to 1 when new pixel group packet transmission starts. For example, in an embodiment the zero-value filter 200 outputs all the compressed packet data for pixel group 1, and then outputs the first compressed packet for pixel group 2 with the group boundary information set to ‘0’ to indicate the start of pixel group 2, and then outputs the remaining compressed packet data for pixel group 2 with the group boundary information set to ‘1’ to indicate they are in the same group. Once all the compressed packet data for pixel group 2 has been output, the zero-value filter 200 then outputs the first compressed packet for pixel group 3 with the group boundary information set to ‘0’ to indicate the start of pixel group 3, and so on.

FIG. 4(a) illustrates an example of non-zero packet data and FIG. 4(b) illustrates an example of packet data wherein all pixel data in a pixel group are zero (0). When the zero flag value of packet data transferred from the zero-value filter 200 is ‘1’, the multiplier 400 may skip all multiplication operations for pixel data of the pixel group for the corresponding packet. For example, if in the example above the first compressed packet for pixel group 3 has the zero flag value set to 1, the multiplier would perform no multiplications using the pixels in pixel group 3. In this case, the first compressed packet for pixel group 3 having the zero flag value set to 1 may be the only packet output for pixel group 3, and the next packet would be for pixel group 4.

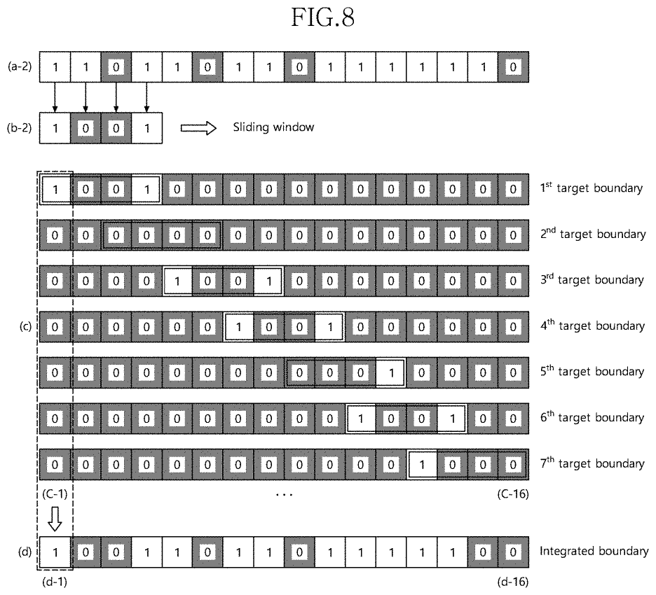

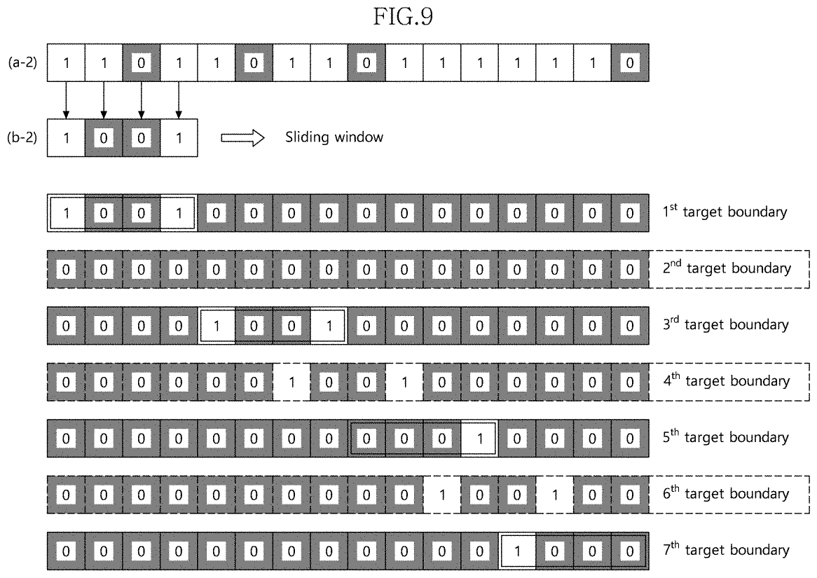

For example, the zero-value filter 200 may inhibit an unnecessary operation of the multiplier 400 in advance by removing values (for example, combinations including zero (0)) expected to cause the unnecessary operation among input values input to the multiplier 400 in advance. For example, in the example shown in FIGS. 2 and 5-8, pixels 1 and 2 of pixel group 1 (corresponding to pixels 2 and 5 in (a) of FIG. 2) are unnecessary, as indicated by the 0 in their respective bits in integrated boundary (d) of FIG. 8. Accordingly, the zero-value filter 200 only transmits compressed packet data for pixels 0 and 3 of group 1 to second memory 300, and the multiplier 400 performs operations using the data for pixels 0 and 3 of group 1 and does not perform operations using the data for pixels 0 or 3 of group 1.

Therefore, the unnecessary latency and power consumption due to the unnecessary operation of the multiplier 400 may be reduced. The multiplier 400 may be a Cartesian product module, that is, a multiplier that multiples the data for each pixel it processes by every coefficient (or at least every non-zero coefficient) in the filter (weight), but embodiments are not limited thereto.

The zero-value filter 200 may convert the input feature and the weight to a one-dimensional (1D) vector and filter non-zero value positions of the input feature and the weight by performing a bitwise OR operation on the input feature and the weight. In this manner, both pixels that have data values of zero and pixels that would not be multiplied by any non-zero filter coefficient are filtered out.

Referring to FIG. 5, the zero-value filter 200 may arrange the 4*4 input feature a to a 1D vector a-1 (for example, 1, 5, 0, 6, 3, 0, 4, 8, 0, 13, 10, 14, 11, 15, 12, 0) according to a filter (weight) size and produce a value a-2 (for example, 1, 1, 0, 1, 1, 0, 1, 1, 0, 1, 1, 1, 1, 1, 1, 0) by performing a bitwise OR operation on each pixel of the input feature a-1 of the 1D vector to extract the non-zero value positions of the input feature a.

Referring to FIG. 6, the zero-value filter 200 may arrange a 2×2 weight b in a 1D vector b-1 (for example, 10, 0, 0, 11) and produce a value b-2 (for example, 1, 0, 0, 1) by performing a bitwise OR operation on the weight b-1 of the 1D vector to extract the non-zero value position of the weight (filter). Accordingly, the zero-value filter 200 may recognize the non-zero value positions of the input feature and recognize the non-zero value positions of the weight.

The zero-value filter 200 may produce non-zero position values according to the positions of the weight for the boundary orders by performing a bitwise AND operation on the filtered non-zero position values of the input feature and weight. For bits of the input feature without corresponding bits in the weight, the bitwise AND operation outputs 0.

The boundary order may be the same as the order that the weight of the 1D vector is subject to sliding window with respect to the input feature of the 1D vector.

Referring to FIGS. 7 and 8, the zero-value filter 200 may locate the non-zero position values of the input feature a-2 and the weight b-2, which are filtered in the 1D vector form, to align with each other and perform a bitwise AND operation on the non-zero position values while sliding a window (shifting) the weight with respect to the input feature. The stride value may be a multiple of a column width (that is, the number of columns) of the 2D filter used to create the 1D weight b-2.

In case of 2×2 filter, the column width may be 2 and therefore, the filter may be shifted by the multiple (=2×1) of column width when stride=1 and may be shifted by the multiple (=2×2) of column width when stride=2.

Referring to FIG. 8, the zero-value filter 200 may produce a plurality of target boundaries c, for example, 1^{st} target boundary to 7^{th} target boundary according to the sliding window of the weight b-2. The 1^{st} target boundary may correspond to the result of a bitwise AND of the input feature a-2 and the weight b-2 when the weight b-2 is unshifted, the 2^{nd} target may correspond to the result of a bitwise AND of the input feature a-2 and the weight b-2 when the weight b-2 is shifted by one column width (for stride=1), the 3^{rd} target may correspond to the result of a bitwise AND of the input feature a-2 and the weight b-2 when the weight b-2 is shifted by two column widths, and so on.

The zero-value filter 200 may produce integrated boundary information by performing a bitwise OR operation on the non-zero position values of the target boundaries.

Referring to FIG. 8, the zero-value filter 200 may produce integrated boundary information d-1 by performing a bitwise OR operation on non-zero position values c-1 (for example, 1, 0, 0, 0, 0, 0, 0) of the 1^{st} target boundary to the 7^{th} target boundary. The zero-value filter 200 may produce integrated boundary information d-2 to d-16 by repeatedly performing bitwise OR operation on non-zero position values c-2 to c-16 of the 1^{st} target boundary to the 7^{th} target boundary and therefore, the final integrated boundary information d may be produced.

When producing the integrated boundary information, the zero-value filter 200 may change the target boundaries on which the bitwise OR operation is to be performed, according to the stride value.

When the stride value is not ‘1’, the zero-value filter 200 may determine the non-zero position values in the integrated boundary information by selectively using the target boundaries according to the stride value in case of the stride value of ‘1’ in FIG. 8.

For example, referring to FIG. 9, when the stride value is ‘2’ (stride=2), the zero-value filter 200 may extract the non-zero position values by not using the even-ordered target boundary information (the 2^{nd} target boundary, the 4^{th} target boundary, and so on) that are used in the case of stride=1 of FIG. 8 when performing the bitwise OR operation that produces the integrated boundary information.

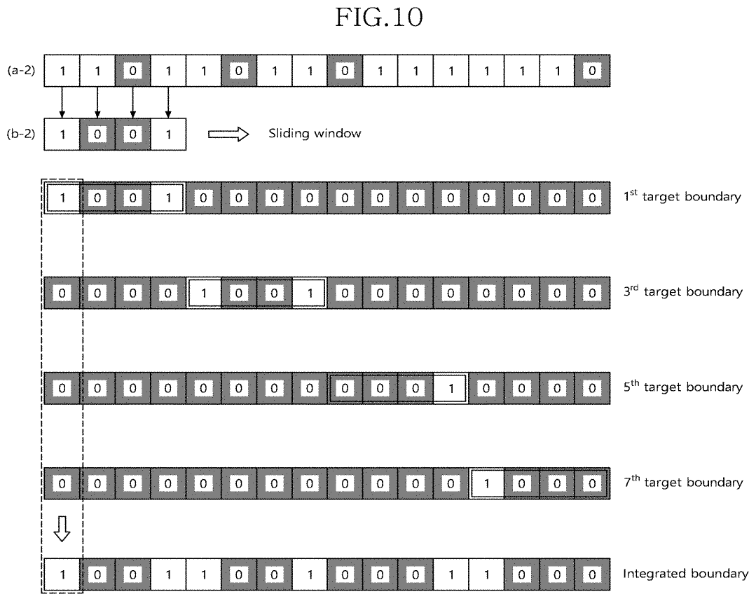

Referring to FIG. 10, the zero-value filter 200 may produce the integrated boundary information by performing a bitwise OR operation on the non-zero position values based on the selected 1^{st} 3^{rd} 5^{th} and, 7^{th} target boundary information.

Even in case of stride=3, the zero-value filter 200 may produce the integrated boundary information by skipping the odd-ordered target boundary information in the case of stride=1 of FIG. 8. The zero-value filter 200 may skip the odd-ordered boundary information other than the 1^{st} boundary information.

The operation of extracting the non-zero value positions in a case where the stride value is not ‘1’ may have the same effect as the method of extracting the non-zero value positions while shifting the filter with respect to the feature of a 2D vector. However, the extraction operation may be implemented with the 1D vector and thus the logic for the extraction operation may be simplified. When the Cartesian product operation is performed after extracting the non-zero position values from the non-zero value positions, the latency and power consumption may be reduced through the skipping of the unnecessary operations.

The second memory 300 may store the packet data including the index information transferred from the zero-value filter 200. The compressed packet data generally only includes packets for pixels for which the corresponding bit in the integrated boundary information is 1 (except, as noted below, in the case where all the pixels in a group are filtered out by the zero-value filter 200). The second memory 300 may store information related to the neural network accelerating apparatus 10 including a final output feature map transferred from the output feature map generator 600. The second memory 300 may be implemented with a static random access memory (SRAM), but embodiments are not limited thereto. Since the second memory 300 reads out one packet data once per cycle due to the SRAM characteristics, many cycles may be required for reading the packet data. Accordingly, the zero-skip operation, which is simultaneously performed with read of the packet data, may be burden on the cycle. However, in the embodiment, since the input feature map in which a plurality of bits are previously processed through the zero-value filtering is stored, the burden on the above-described cycle may be reduced. That is, the embodiment can relatively reduce the number of times of accessing the second memory 300 for reading the packet data.

The multiplier 400 which is a Cartesian product module may produce result data by performing a multiplication operation on the input feature and the weight as represented in the compressed packet data stored in the second memory 300.

The multiplier 400 may skip the multiplication operation to the zero value-filtered packet data with reference to the index information in performing of the multiplication operation.

The feature map extractor 500 may perform an addition operation between multiplied result data based on the relative coordinates and the boundary information of the result data transferred from the multiplier 400 and generate the output feature map by rearranging the result values of the addition operation in the original input feature form. For example, the feature map extractor 500 may rearrange the added result values in the form (see a of FIG. 2) that the pixels were in before pixel grouping, based on the relative coordinates and the boundary information.

The output feature map generator 600 may change the output feature map to nonlinear values by applying an activation function to the output feature map, generate the final output feature map by performing a pooling process on the nonlinear values, and transmit the final output feature map to at least one of the first memory 100, the second memory 300, and the zero-value filter 200.

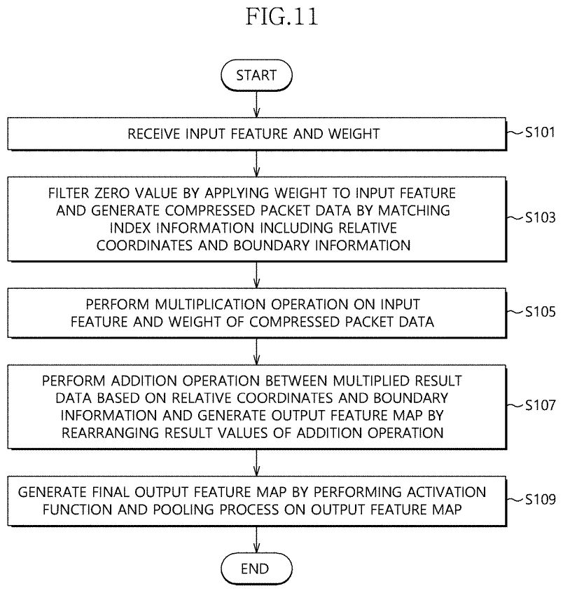

FIG. 11 is a flowchart explaining an operating method of a neural network accelerating apparatus according to an embodiment.

Referring to FIG. 11, the zero-value filter 200 of the neural network accelerating apparatus 10 may receive an input feature and a weight (S101).

Referring to FIG. 1, the zero-value filter 200 may receive the pre-stored input feature and weight from the first memory 100.

Next, the zero-value filter 200 may filter the zero (0) value from the input feature by applying the weight to the input feature and generate compressed packet data by matching index information including the relative coordinate and group boundary information for pixels of the input feature (S103).

For example, the zero-value filter 200 may perform the zero-value filtering using zero-value positions of the input feature and the weight and the stride value.

Further, the zero-value filter 200 may group the pixels of the input feature according to a preset criterion, generate relative coordinates between a plurality of groups, and match the relative coordinates with pixels of each group.

The multiplier 400 of the neural network accelerating apparatus 10 may produce result data by performing a multiplication operation on the input feature and the weight of the compressed packet data transferred from the zero-value filter 200 (S105). The multiplier 400 may not directly receive the compressed packet data from the zero-value filter 200 but may receive the compressed packet data from the second memory 300.

Referring to FIGS. 3 and 4, the compressed packet data may include group boundary information “boundary indicator”, a zero flag “all 0 flag” indicating whether all corresponding pixel data have a zero (0) value, a coordinate “coordinate info” of the pixel data, and pixel data “Data”. The group boundary information may be the integrated boundary information acquired by performing a bitwise OR operation on the non-zero position values for the boundary orders through the zero-value filter 200.

Referring to FIG. 8, the zero-value filter 200 may produce the integrated boundary information d-1 by performing a bitwise OR operation on the non-zero position values c-1 (for example, 1, 0, 0, 0, 0, 0, 0) of the 1^{st} target boundary to the 7^{th} target boundary. The integrated boundary information is then used to determine which pixels the zero-value filter 200 will generate compressed packet data for.

When performing the multiplication operation, the multiplier 400 may skip the multiplication operation for the zero value-filtered packet data with reference to the index information. For example, when the zero flag value of the packet data transmitted from the zero-value filter 200 is 1′, the multiplier 400 may skip all the multiplication operations on the pixel data of the pixel group corresponding to the packet data. In this example, the zero value-removed packet data is stored in the second memory 300, and therefore the unnecessary data may be removed in a stage previous to the multiplier 400. The full zero skip operation may be an exception to the general case wherein packet data is not stored for pixels filtered out by the zero-value filter 200.

In an embodiment, the multiplier 400 proceeds packet by packet through the compressed packet data in the second memory 300. When the zero flag value of the packet is ‘0’, the multiplier 400 multiplies the pixel data in the packet by at least each of the non-zero coefficients of the filter to produce one multiplication result for each non-zero filter coefficient, and outputs a result for that packet including the group boundary information, zero flag value, and the relative coordinates of the packet and the results of the multiplications. When the zero flag value of the packet is ‘1’, the multiplier 400 just outputs a result for the packet including the group boundary information, zero flag value, and relative coordinates (of zero) of the packet and, in some embodiments, zeros for the multiplication results. Accordingly, the unnecessary latency and power consumption caused in the unnecessary operation of the multiplier 400 may be reduced.

Next, the feature map extractor 500 may perform an addition operation between the multiplied result data based on the relative coordinates and the group boundary information of the result data and generate an output feature map by rearranging the added result values in the original input feature form (S107). For example, in an embodiment, for each output corresponding to a packet of the multiplier 400, the feature map extractor 500 may determine which pixels in the output feature map use each of the multiplication results in the output, and may accumulate that multiplication results into that pixel.

The output feature map generator 600 may change the output feature map to nonlinear values by applying the activation function to the output feature map and generate a final output feature map by performing a pooling process (S109).

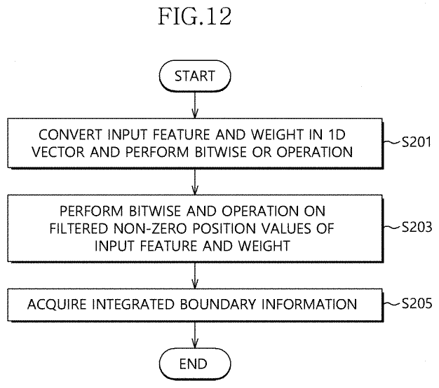

FIG. 12 is a diagram explaining operation S103 of generating the compressed packet data in FIG. 11 in more detail.

Referring to FIG. 12, the zero-value filter 200 of the neural network accelerating apparatus 10 may convert the input feature and the weight to a 1D vector and filter the non-zero value positions of the input feature and the weight by performing a bitwise OR operation on the pixels of the input feature and the coefficients of the weight (S201).

Referring to FIG. 5, the zero-value filter 200 may arrange the 4*4 input feature a in a 1D vector a-1 (for example, 1, 5, 0, 6, 3, 0, 4, 8, 0, 13, 10, 14, 11, 15, 12, 0) according to a filter (weight) size and produce a value a-2 (for example, 1, 1, 0, 1, 1, 0, 1, 1, 0, 1, 1, 1, 1, 1, 1, 0) by performing a bitwise OR operation on the input feature a-1 of the 1D vector to extract the non-zero value positions of the input feature a.

Referring to FIG. 6, the zero-value filter 200 may arrange 2×2 weight b in a 1D vector b-1 (for example, 10, 0, 0, 11) and produce a value b-2 (for example, 1, 0, 0, 1) by performing a bitwise OR operation on the weight b-1 of the 1D vector to extract the non-zero value position of the weight (filter). Accordingly, the zero-value filter 200 may recognize the non-zero value positions of the feature (indicated by 1's in a-2) and the weight (indicated by 1's in b-2).

The zero-value filter 200 may produce the non-zero position values according to the weight positions for the boundary orders by performing a bitwise AND operation on the filtered non-zero position values of the input feature and weight (S203).

The boundary order may be the same as the order that the weight of the 1D vector is applied using a sliding window to the input feature of the 1D vector.

Referring to FIGS. 7 and 8, the zero-value filter 200 may locate the non-zero position values of the input feature a-2 and the weight b-2, which are filtered in the 1D vector form, to align with each other and perform a bitwise AND operation on the non-zero position values while sliding a window (or shifting) of the weight with respect to the input feature. The stride value, that is, the amount that the sliding window is shifted each time it is moved, may be a multiple of a column width of a 2D filter corresponding to the weight.

Referring to FIG. 8, the zero-value filter 200 may produce a plurality of target boundaries c, for example, 1^{st} target boundary to 7^{th} target boundary respectively corresponding to positions of the sliding window of the weight b-2.

Next, the zero-value filter 200 may produce integrated boundary information by performing a bitwise OR operation on the non-zero position values for the target boundaries (S205). The integrated boundary information may be included in the boundary information of the index information in operation S103 described above.

Referring to FIG. 8, the zero-value filter 200 may produce the integrated boundary information d-1 by performing a bitwise OR operation on the non-zero position values c-1 (for example, 1, 0, 0, 0, 0, 0, 0) of the 1^{st} target boundary to the 7^{th} target boundary. The zero-value filter 200 may produce integrated boundary information d-2 to d-16 by repeatedly performing bitwise OR operation on non-zero position values c-2 to c-16 of the 1^{st} target boundary to the 7^{th} target boundary and therefore, the final integrated boundary information d may be produced.

When producing the integrated boundary information in operation S205, the zero-value filter 200 may change the target boundary information on which the bitwise OR operation is to be performed, according to the stride value.

The above described embodiments of the present invention are intended to illustrate and not to limit the present invention. Various alternatives and equivalents are possible. The invention is not limited by the embodiments described herein. Nor is the invention limited to any specific type of semiconductor device. Other additions, subtractions, or modifications are obvious in view of the present disclosure and are intended to fall within the scope of the appended claims.

What is claimed is:

1. A neural network accelerating apparatus comprising:
a zero-value filter configured to filter a zero (0) value by applying a weight to an input feature, the input feature including a plurality of data elements, and generate compressed packet data by matching index information including relative coordinates and group boundary information with the data elements of the input feature;
a multiplier configured to produce result data by performing a multiplication operation on the input feature and the weight of the compressed packet data; and
a feature map extractor configured to perform an addition operation between the result data based on the relative coordinates and the group boundary information and generate an output feature map by rearranging result values of the addition operation in an original input feature form.

2. The neural network accelerating apparatus of claim 1, further comprising an output feature map generator configured to change the output feature map to nonlinear values by applying an activation function to the output feature map, generate a final output feature map by performing a pooling process, and transmit the final output feature map to any one of a first memory, a second memory, and the zero-value filter.

3. The neural network accelerating apparatus of claim 1, wherein the zero-value filter performs the zero-value filtering using zero-value positions of the input feature, zero-value positions of the weight, and a stride value.

4. The neural network accelerating apparatus of claim 1, wherein the zero-value filter groups the data elements of the input feature according to a preset criterion, generates the relative coordinates between a plurality of groups, and matches the relative coordinates with data elements of each group.

5. The neural network accelerating apparatus of claim 4, wherein the group boundary information is 1-bit information for dividing the plurality of groups.

6. The neural network accelerating apparatus of claim 1, wherein the zero-value filter converts the input feature and the weight to a one-dimensional (1D) vector, filters non-zero value positions of the input feature and the weight by performing a bitwise OR operation on the input feature and the weight, and produces non-zero position values according to weight positions for target boundaries by performing a bitwise AND operation on filtered non-zero position values of the input feature and weight.

7. The neural network accelerating apparatus of claim 6, wherein the zero-value filter produces integrated boundary information by performing a bitwise OR operation on the non-zero position values for the target boundaries.

8. The neural network accelerating apparatus of claim 7, wherein the zero-value filter changes the target boundaries on which the bitwise OR operation is to be performed according to a stride value when producing the integrated boundary information.

9. The neural network accelerating apparatus of claim 6, wherein each target boundary corresponds to a respective position of a sliding window by which the weight as converted to the 1D vector is applied to the input feature as converted to the 1D vector.

10. The neural network accelerating apparatus of claim 1, wherein the multiplier skips the multiplication operation for the zero value-filtered compressed packet data with reference to the index information when performing the multiplication operation.

11. The neural network accelerating apparatus of claim 1, further comprising:
a first memory configured to store the input feature and the weight; and
a second memory configured to store the compressed packet data including the index information transferred from the zero-value filter.

12. An operating method of a neural network accelerating apparatus, the operating method comprising:
receiving an input feature and a weight, the input feature including a plurality of data elements;
filtering a zero (0) value by applying the weight to the input feature and generating compressed packet data by matching index information including relative coordinates and group boundary information for the data elements of the input feature;
producing result data by performing a multiplication operation on the input feature and the weight of the compressed packet data;
performing an addition operation between multiplied result data based on the relative coordinates and the group boundary information of the result data and generating an output feature map by rearranging result values of the addition operation in an original input feature form; and
changing the output feature map to nonlinear values by applying an activation function to the output feature map and generating a final output feature map by performing a pooling process.

13. The method of claim 12, wherein the generating of the compressed packet data includes performing the zero-value filtering using zero-value positions of the input feature, zero-value positions of the weight, and a stride value.

14. The method of claim 12, wherein the generating of the compressed packet data includes grouping the data elements of the input feature according to a preset criterion, generating the relative coordinates between a plurality of groups, and matching the relative coordinates with data elements of each group.

15. The method of claim 12, wherein the generating of the compressed packet data includes:
converting the input feature and the weight in a one-dimensional (1D) vector and filtering non-zero value positions of the input feature and the weight by performing a bitwise OR operation on the input feature and the weight;
producing non-zero position values according to weight positions for target boundaries by performing a bitwise AND operation on filtered non-zero position values of the input feature and the weight; and
producing integrated boundary information by performing a bitwise OR operation on the non-zero position values for the target boundaries.

16. The method of claim 15, wherein producing of the integrated boundary information includes changing the target boundaries on which the bitwise OR operation is to be performed according to a stride value.

17. The method of claim 15, wherein each target boundary corresponds to a respective position of a sliding window by which the weight as converted to the 1D vector is applied to the input feature as converted to the 1D vector.
